(19) United States
(12) Patent Application Publication
(10) Pub. No.: US 2026/0117149 A1
(43) Pub. Date: Apr. 30, 2026

(54) DUAL CHAMBER HYPOHALITE CONCENTRATE AND DILUTION SYSTEM

(71) Applicant: THE CLOROX COMPANY, Oakland, CA (US)

(72) Inventors: Bryan Parrish, Pleasanton, CA (US); Evan Rumberger, Pleasanton, CA (US); Mikayla Barry, Pleasanton, CA (US); Mark Pszczolkowski, Pleasanton, CA (US)

(21) Appl. No.: 18/929,866

(22) Filed: Oct. 29, 2024

(51) Int. Cl. C11D 17/04; C11D 1/14; C11D 3/00; C11D 3/04; C11D 3/12; C11D 3/37; C11D 3/48; C11D 3/50

(52) U.S. Cl. CPC C11D 17/045; C11D 1/143; C11D 3/0047; C11D 3/04; C11D 3/1213; C11D 3/1233; C11D 3/3746; C11D 3/48; C11D 3/50; C11D 17/043

(57) ABSTRACT

A cleaning concentrate dilution system includes a dual chamber system in which a plurality of concentrated formulations are provided, including a first formulation provided in a first chamber and including a hypohalite, and a second formulation provided in a second chamber and including one or more components that are sensitive to concentrated hypohalite, such as certain surfactants and certain fragrances. The system further includes a dispensing container that receives the first and second formulations as well as water to dilute the first and second formulations within the dispensing container.

### FIELD

The present invention is directed toward hypohalite formulations for cleaning, stain removal, and antimicrobial uses.

### BACKGROUND

Hypohalites such as sodium hypochlorite are highly effective cleaning, bleaching and sanitizing agents used for a variety of purposes, including in the washing of certain textiles, stain removal (e.g., oxidation/whitening) of certain textiles or surfaces, the cleaning and disinfecting and/or sanitizing of surfaces or items (e.g., destruction of bacteria and/or viruses), the removal of mold and mildew from certain surfaces, etc.

Bleach formulations (e.g., aqueous solutions containing sodium hypochlorite) are particularly useful and common in both industrial and domestic applications, with many households typically containing some form of bleach solution for laundry and cleaning uses.

Given the varied uses of hypohalite solutions, it would be advantageous to provide a hypohalite solution in concentrated form that facilitates dilution with water to form a less concentrated or dilute hypohalite solution for the uses as noted herein. Thus, a small volume of a concentrated hypohalite solution can be provided to form a much greater volume diluted solution that is still effective for use. However, a highly concentrated hypohalite solution may not be stable for long periods of time, particularly when combined with other agents such as surfactants and fragrances. In particular, certain types of surfactants and fragrances can decompose or degrade when stored for longer periods of time in a concentrated solution of hypohalite prior to being diluted with water.

Accordingly, it would be advantageous to provide a system in which a cleaning product can be formed from dilution of a concentrated form of hypohalite while further ensuring adequate preservation and stability of surfactants, fragrances and other additives prior to dilution as well as after dilution for a suitable period of time prior to use of the cleaning product.

### BRIEF SUMMARY

In accordance with embodiments described herein, a cleaning concentrate dilution system comprises a dual chamber system in which a plurality of concentrated formulations are provided, including a first formulation provided in a first chamber and comprising a hypohalite, and a second formulation provided in a second chamber and comprising one or more components that are sensitive to concentrated hypohalite, such as certain surfactants and certain fragrances. The system further comprises a dispensing container that receives the first and second formulations as well as water to dilute the first and second formulations within the dispensing container.

In an example embodiment, a cleaning concentrate dilution system includes a concentrate comprising a first formulation and a second formulation. The system comprises a first scaled container containing a first formulation. The first formulation comprises a hypohalite in an amount from about 1% to about 20% by combined weight of the first formulation and the second formulation, a first pH adjusting agent in an amount from about 0.01% to about 5% by combined weight of the first formulation and the second formulation, and, optionally, a first solvent, a first colorant, water, or any mixture or combination thereof. The system further comprises a second sealed container containing the second formulation, the second formulation comprising a surfactant in an amount from about 1% to about 40% by combined weight of the first formulation and the second formulation, a fragrance in an amount from about 0.01% to about 10% by combined weight of the first formulation and the second formulation, and, optionally, a solvent, a second colorant, a polymer, water, one or more pH adjusting agents or any mixture or combination thereof. At least one sealing structure covers a first opening in the first container or a second opening in the second container or both the first and second openings. The system further comprises a dispensing container having a greater volume than the first and second sealed containers combined, which is formatted to contain a stable dilute cleaning formulation comprising the first formulation, the second formulation, and a tap water. The dilute cleaning formulation has a 1:10-1:20 dilution of the concentrated first and second formulations combined with the tap water.

In another example embodiment, a sealed concentrate cleaning product includes a concentrate comprising a first formulation and a second formulation, the concentrate cleaning product comprising a first sealed container containing the first formulation and a second sealed container containing the second formulation. The first formulation comprises a hypochlorite in an amount from about 1% to about 20% by combined weight of the first formulation and the second formulation, a first pH adjusting agent in an amount from about 0.01% to about 5% by combined weight of the first formulation and the second formulation, and, optionally, a first solvent, a first colorant, water, or any mixture or combination thereof. The second formulation comprises a surfactant in an amount from about 1% to about 40% by combined weight of the first formulation and the second formulation, a fragrance in an amount from about 0.01% to about 10% by combined weight of the first formulation and the second formulation, and, optionally, a second colorant, a second solvent, a polymer, water, a pH adjusting agent, or any mixture or combination thereof. At least one sealing structure covers a first opening in the first container or a second opening in the second container or both the first and second openings, where the sealing structure covering the first opening comprises a bleach stable material.

In a further example embodiment, a sealed concentrate cleaning product includes a concentrate comprising a first formulation and a second formulation. The concentrate cleaning product comprises a first sealed container containing a first formulation and a second sealed container containing a second formulation. The first formulation comprises a hypochlorite in an amount from about 1% to about 20% by combined weight of the first formulation and the second formulation, a first pH adjusting agent in an amount from about 0.01% to about 5% by combined weight of the first formulation and the second formulation, a second pH adjusting agent in an amount from about 0.01% to about 5% by combined weight of the first formulation and the second formulation, and, optionally, a first colorant, water, or any mixture or combination thereof. The second formulation comprises an anionic surfactant in an amount from about 1% to about 40% by combined weight of the first formulation and the second formulation, a fragrance in an amount from about 0.01% to about 10% by combined weight of the first formulation and the second formulation, and, optionally, a polymer, a second colorant, water, one or more pH adjusting agents, or any mixture or combination thereof. At least one sealing structure covers a first opening in the first container or a second opening in the second container or both the first and second openings, the sealing structure covering the first opening comprises a bleach stable material.

Embodiments described herein also include methods of facilitating the formation of a dilute cleaning formulation from the concentrated first and second formulations combined with tap water and that is shelf stable as described herein.

The above and still further features and advantages of the present invention will become apparent upon consideration of the following detailed description of specific embodiments thereof.

### BRIEF DESCRIPTION OF THE DRAWINGS

FIG. 1 is a plot of data showing stability for samples of single chamber concentrated formulations and dual chamber concentrated formulations over time based upon measurement of hypochlorite concentration in such formulations over a period of 28 days and at an elevated temperature of 100° F. (40° C.).

### DETAILED DESCRIPTION

In the following detailed description, while aspects of the disclosure are disclosed, alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used herein, are synonymous and are open-ended terms that do not exclude additional, unrecited elements or method steps. The term “consisting of”, as used herein, excludes any element or method step that is not specified in a claim. The term “consisting essentially of”, as used herein, limits the scope of a claim to specific recited elements and method steps and as well as unrecited elements and unrecited steps that do not materially affect the basic and novel characteristics of the claimed invention. The terms “a” and “an” can refer to plural elements unless clearly indicated otherwise (e.g., “an excipient” can include, one, two or more excipients).

The term “effective amount”, as used herein, generally refers to amounts described within ranges as noted herein. Also, unless indicated otherwise, the term “percentage”, as used herein, refers to a weight percent based upon a particular material that is referenced. For example, an excipient, active ingredient or component that is present in an amount of 1% of a formulation or other composition indicates that the excipient, active ingredient or other component is present in the formulation or composition as 1% by total weight of the formulation or composition. Such term is also referred to herein as “wt %” or “% by weight”. Similarly, the term “ppm” refers to parts per million on a weight/weight basis, such that, e.g., 100 ppm refers to 0.01% by weight (or 0.01 wt %). Further, the term “about” as used herein in relation to a described amount indicates that the amount can deviate or vary slightly beyond the described value by no more than 5% (e.g., “about 1% by weight” also includes a range of 0.95-1.05% by weight) while substantially maintaining the same efficacy of the formulation. In addition, the term “formulation”, as used herein (e.g., a concentrated or a dilute hypohalite formulation), refers to an aqueous liquid composition including two or more ingredients or components.

The term “tap water”, as used herein, generally refers to water obtained directly from a faucet or tap, e.g., from a residential, commercial or industrial facility, in which the water is provided from a public utility or via a well (ground water) and that has not been further purified, distilled or treated in any other manner beyond the faucet or tap. This is in contrast to “treated water”, which refers to water that undergoes a process that improves the quality or consistency of the water to make it appropriate for a specific end-use. For example, treated water may be water treated to remove a wide variety of contaminants, including but not limited to: bacteria, viruses, microbes, metals, minerals, chemicals, sediment, solids and other any other suitable contaminants. Treated water includes deionized water, distilled water, reverse osmosis water, soft water, filtered water, and water which may be treated by another suitable method for removal or inactivation of contaminants. The term “water”, as used herein (without further designation), refers to both tap water and treated water.

In accordance with example embodiments, a dual chamber hypohalite concentration system is described herein that can be used to form an effective cleaning solution by combining formulations from two different, separate and isolated chambers or containers of the system with water at a specified dilution ratio to form the cleaning solution. The cleaning solution that is formed is effective in cleaning, removing stains from and/or bleaching textiles or other items, as well as sanitizing and/or sterilizing objects or surfaces (e.g., in residential, commercial and/or industrial environments). For example, the dual chamber hypohalite concentration system can include a first formulation in a first chamber or container comprising hypohalite in concentrated form, while a second formulation is provided in a second chamber or container that is separate and isolated from the first chamber. The second formulation includes one or more components (e.g., a surfactant, a fragrance, etc.) that may be sensitive and potentially subject to chemical reaction and/or degradation when combined with concentrated hypohalite over a certain period of time. Each of the first formulation and second formulation includes components that are in concentrated form, since combination of the first and second formulations are diluted in water to form the cleaning solution resulting in the concentration of each component being lower than in their respective concentrated (i.e., first or second) formulation.

By maintaining separation and isolation (within different chambers) of the concentrated hypohalite from components that may be sensitive to the concentrated hypohalite up to the point in time of dilution with water, the resultant cleaning solution that is formed by combining all of these components is rendered effective for use for prolonged periods of time in which the sensitive components function in the intended manner within the cleaning solution for such prolonged periods of time. The desired concentration or concentration range of each component can be achieved prior to use by maintaining separation of components that may react and/or interact in some manner with each other to reduce their concentrations prior to dilution and/or use for cleaning operations. In particular, the first formulation can comprise a concentrated hypohalite formulation that is stable for prolonged periods of time (e.g., having a shelf-life of one year or longer) prior to use and prior to activation by combination with the second formulation and water. Similarly, the second formulation can include components such as a surfactant, a fragrance, a solvent, etc., where the second formulation is also stable for prolonged periods of time (e.g., having a shelf-life of one year or longer) prior to use and prior to activation by combination with the second formulation and water (due to limiting the interaction/exposure to components in the first formulation prior to use). Further still, the cleaning formulation that is formed by combination of the first and second formulations with water is also stable for prolonged periods of time (e.g., having a shelf-life of one year or longer).

The dual chamber storage system can comprise a single container or pod that is subdivided with any suitable interior wall or barrier into a plurality of (e.g., two) chambers that are self-contained, separated and isolated from each other within the single container or pod and where each chamber includes a different concentrated formulation as described herein. Alternatively, the dual chamber storage system can comprise a plurality of (e.g., two) separate containers, each of which includes a single chamber for storage of one of the concentrated formulations. The system can further comprise a cleaning product container that is suitable to receive all or portions of each concentrated formulation from the separate chambers along with water (e.g., tap water) to dilute the concentrations of components within the cleaning product container when each concentrated formulation is combined with water within the cleaning product container. The cleaning product container can have a greater volume than one or more of the chambers containing concentrated formulations.

To be effective for oxidative stain removal, bleaching formulations often require sodium hypochlorite in an amount of 1-2% by weight in an aqueous solution. A concentrate that would dilute to this amount of sodium hypochlorite would require a much greater amount of sodium hypochlorite in the concentrate. For example, an effective concentrate that would form a dilute 1-2% bleach formulation would typically require a 12×, or 12-24% bleach formulation (i.e., aqueous solution containing 12-24% by weight of sodium hypochlorite). Such a heavily concentrated bleach formulation would not be stable for extended periods of time, particularly with the addition of a surfactant and/or a fragrance to the bleach formulation.

It has been determined that, by separating certain components in the dilute hypohalite formulation prior to dilution, effective bleaching/oxidative stain removal properties can be achieved with a wide range of concentrations of hypohalite in the concentrated formulations. In particular, the separation of a concentrate dilution system into a plurality (e.g., two) concentrated formulations facilitates the provision of concentrated hypohalite formulations including hypohalite in a wide range of concentrations, including high concentrations (e.g., 24% by weight or greater) and smaller concentrations (e.g., 1% by weight or less) while still maintaining stability of the components in each concentrated formulation.

In example embodiments, the cleaning concentrate dilution system includes a concentrate that comprises a concentrated first formulation comprising the concentrated hypohalite and a separate, concentrated second formulation comprising components that may be sensitive to hypohalite in concentrated form including, without limitation, certain surfactants and fragrances. In particular, the first formulation can include a hypohalite (e.g., hypochlorite) in an amount from about 1% to about 20% by weight of the combined concentrated formulations (i.e., the total or combined amount of the first and second formulations), and a pH adjusting agent in an amount from about 0.01% to about 5% by weight of the combined concentrated formulations. The first formulation can also optionally include a solvent, a fragrance that is not sensitive to the hypohalite in concentrated form, a colorant, water, or any mixture or combination thereof. The second formulation can include a surfactant in an amount from about 1% to about 40% by weight of the combined concentrated formulations, and a fragrance that is sensitive to concentrated hypohalite in an amount from about 0.01% to about 10% by weight of the combined concentrated formulations. The second formulation can further optionally include a colorant (e.g., same or different colorant as the first formulation), a solvent (e.g., same or different solvent as the first formulation), a polymer, one or more pH adjusting agents (e.g., same or different pH adjusting agent(s) as the first formulation), water, or any mixture or combination thereof.

The first formulation, which can comprise concentrated hypohalite (e.g., sodium hypochlorite) in an amount ranging from about 1% to about 20% by weight of the combined concentrated formulations, allows for a very broad dilution ratio when diluted with water. In particular, the first formulation having the amount in this concentration range can be diluted with water at a dilution ratio from about 1:4 to about 1:64 to achieve a cleaning solution having the desired diluted concentration of hypohalite, thus rendering the first formulation suitable for forming a cleaning solution effective for a variety of cleaning and disinfecting operations.

The amount of available halide oxidant can be provided in any suitable manner within the concentrated, first formulation as well as the dilute cleaning formulation. In the example embodiments described herein, hypochlorite is added in the first formulation so as to provide free available chlorine as an active ingredient in solution for performing bleaching, stain removal, and cleaning (e.g., sanitizing and/or disinfecting) operations during use of the dilute cleaning formulations. However, other halides can be alternatively added or even added in addition to chloride oxidant so as to provide similar efficacy at the same or similar dosage amounts and in similar formulations (e.g., utilizing similar buffer systems, similar surfactants, etc.). The halides can be added as hypohalites (i.e., salts of hypohalous acids) to form formulations as described herein. Alternatively, any other suitable form of halide can be added to facilitate generation of solubilized active halide within a formulation. Examples of suitable halide oxidants that can be present in formulations as described herein include, but without limitation, hypochlorous acid, hypobromous acid, alkaline metal salts and/or alkaline earth metal salts of hypochlorous acid, alkaline metal salts and/or alkaline earth metal salts of hypobromous acid, solubilized chlorine, solubilized bromine and/or any other solubilized halide, solubilized chlorine dioxide, sodium chlorite, any other suitable active chlorine compounds or other active halide compounds, and any combinations thereof.

The amount of halide oxidant component (broadly referred to herein as a hypohalite or free available halide oxidant) can be many times greater (e.g., 10× to 20× greater) in the concentrated formulation in comparison to the dilute formulation. In example embodiments, a concentrated hypohalite formulation (e.g., formulation with hypochlorite) comprises from about 0.25% to about 22% by weight (i.e., by weight of the combined concentrated formulations), such as from about 0.50% to about 21% by weight, or from about 1% to about 20% by weight.

Upon combination of the first formulation with the second formulation and the addition of water, hypohalite is present in the dilute cleaning formulation (e.g., formulation with hypochlorite) in an amount ranging from about 0.005% to about 10%, or from about 0.01% to about 8%, or from about 0.01% to about 5%, or from about 0.1% to about 2% by weight of the dilute cleaning formulation.

In forming the dilute cleaning formulations as described herein, the dilution ratio can be at least 1:4, where water is added to the concentrated formulations so as to increase the total formulation volume (and also reduce the amounts in weight percentages of each component) by a factor of at least 4. For example, depending upon particular applications of use and how the concentrated formulations are provided, the 1:X dilution ratio of the concentrated formulations with water to form dilute cleaning formulation (e.g., unit volume of the combined concentrated formulations to unit volume of dilute cleaning formulation) can be from 1:4 to 1:64 or greater, such as 1:10 to 1:20, or 1:4, or 1:5, or 1:6, or 1:7, or 1:8, or 1:9, or 1:10, or 1:11, or 1:12, . . . , or 1:18, or 1:19, or 1:20, or 1:21, or 1:22, . . . , or 1:28, or 1:29, or 1:30, or 1:31, or 1:32, . . . , or 1:48, or 1:49, or 1:50, or 1:51, or 1:52, . . . , or 1:58, or 1:59, or 1:60, or 1:61, or 1:62, or 1:63, or 1:64, or even greater. Since the dilution is with water, a corresponding decrease in weight percentage of the hypohalite as well as other components can be decreased by a similar ratio (e.g., a 1:10 dilution ratio will achieve about a 10× reduction in concentration as measured by weight percentage of hypohalite from concentrated formulation to dilute cleaning formulation).

In forming the combined first and second formulations, the first and second formulations can be provided in the same amounts (e.g., same amounts by weight) in each of the first and second chambers or containers housing these concentrated formulations. In example embodiments, the second formulation is provided in the same or greater amount in relation to the first formulation. Alternatively, the first formulation can be provided in a greater amount in relation to the second formulation. Some non-limiting examples of a ratio by weight of first formulation (which include hypohalite) to second formulation can be 10:90, or 20:80, or 30:70, or 40:60 or 50:50, or 60:40, or 70:30, or 80:20, or 90:10. In certain example embodiments, a weight ratio first formulation to second formulation to form the combined first and second formulations can be from 50:50 to 90:10.

A buffer system can be provided for the cleaning concentrate dilution system which can include components including, without limitation, one or more pH adjusting agents and one or more surfactants (e.g., one or more anionic surfactants). The buffer system can be important in maintaining stability and effectiveness of the hypohalite formulations (both concentrated and diluted for use) as described herein. In particular, a buffer system is provided in the hypohalite formulations that lowers and maintains the pH of the dilute hypohalite formulations and further results in more effective oxidative stain removal at the lower hypohalite concentration. The buffer system can include one or a variety of surfactants, preferably anionic surfactants as described herein. The components of the buffer system can be partitioned into the first formulation (concentrated hypohalite formulation) and the second formulation so as to maintain stability of certain surfactants used and thus the longevity of the dilute cleaning formulation.

Some pH adjusting agents can be provided in the first formulation, while other pH adjusting agents are separated from the concentrated hypohalite and thus provided in the second formulation. Further still, one or more of the same pH adjusting agents can be provided in each of the first formulation and the second formulation. The one or more pH adjusting agents of the buffer system provide a stable dilute cleaning formulation at a desired pH. In particular, the one or more pH adjusting agents for the buffer system can be present in the first formulation and/or in the second formulation in an amount no greater than about 5.0% by weight of the combined concentrated formulations and can be present in the dilute formulation in an amount no greater than about 0.30% by weight (i.e., by weight of the dilute cleaning formulation).

Suitable pH adjusting agents that can be provided in the buffer system include silicate salts (e.g., sodium silicate, sodium metasilicate, sodium orthosilicate, potassium silicate, potassium metasilicate, potassium orthosilicate, etc.), phosphate salts (e.g., sodium phosphate, sodium polyphosphate, potassium phosphate, potassium polyphosphate, etc.), carbonate salts (e.g. sodium carbonate, sodium bicarbonate, potassium carbonate, potassium bicarbonate, etc.), borate salts (e.g., sodium borate, potassium borate, etc.), and combinations or mixtures thereof. Suitable pH adjusting agents can also include acids or bases such as hydroxides (e.g., sodium hydroxide, potassium hydroxide, etc.). In particular, the buffer system can comprise a combination of pH adjusting agents comprising a carbonate and a hydroxide (e.g., sodium carbonate and sodium hydroxide).

In example embodiments, the amount of one or more pH adjusting agents within one or both of the first formulation and the second formulation can be from about 0.2% to about 5.0% by weight (i.e., by weight of the combined concentrated formulations), or from about 0.2% to about 2.5% by weight, or from about 0.2% to about 2.0% by weight, or from about 0.5% to about 1.5% by weight, or from about 0.8% to about 1.4% by weight. The amount of one or more pH adjusting agents within the dilute cleaning formulation can be from about 0.025% to about 0.30% by weight (i.e., by weight of the dilute cleaning formulation), or from about 0.025% to about 0.28% by weight, or even from about 0.03% to about 0.25% by weight.

The buffer systems can also include one or more stability agents. Providing certain stability agents, such as one or more polymers such as polyacrylates, to the dilute hypohalite formulation is particularly important to ensure stability of the dilute formulation regardless of the hardness of water being added to form the dilute formulation. This allows a user/consumer to form the dilute formulation from the concentrated formulation without the requirement of using purified/distilled water. Instead, tap water (e.g., water provided from a public utility or locally sourced, e.g., well water) can be used to form the dilute hypohalite formulation without the concern of significant degradation of the dilute hypohalite formulation for an extended period of time. In example embodiments, a polyacrylate can be provided as a stability agent in the purified cleaning solution in an effective amount to minimize any effect of impurities such as minerals (e.g., calcium and magnesium) in hard water that might otherwise degrade one or more components within the dilute cleaning formulation. A non-limiting example of a specific embodiment of an acrylate that is suitable for enhancing the stability of the dilute hypohalite formulation that includes tap water is a sodium polyacrylate compound that is commercially available under the tradename SOKALAN PA 25 CL PN (BASF, Germany).

The one or more stability agents (e.g., polyacrylate compound) can be provided in the first formulation and/or the second formulation. In example embodiments, the one or more stability agents is provided in only the second formulation. The amount of one or more stability agents can be provided in the first formulation and/or the second formulation in an amount ranging from about 0.0005% to about 5% by weight (i.e., by weight of the combined concentrated formulations), or from about 0.01% to about 5%, or from about 0.01% to about 4% by weight, or from about 0.01% to about 3% by weight, or from about 0.01% to about 2% by weight, or from about 0.01% to about 1% by weight, or even from about 0.01% to about 0.5% by weight. The amount of one or more stability agents in the dilute cleaning formulation can be in an amount ranging from about 0.0001% to about 0.5% by weight (i.e., by weight of the dilute cleaning formulation).

One or more surfactants and, in particular, one or more anionic and/or non-ionic surfactants, are provided to the first formulation and/or the second formulation to enhance uniform distribution, uniform wetting and/or uniform penetration properties of the formulations as well as the micro efficacy of the dilute cleaning formulation during use.

In example embodiments, the one or more surfactants comprise anionic, non-ionic and/or amphoteric surfactants that are provided in only the second formulation, or at least any surfactant that is sensitive to the concentrated hypohalite of the first formulation is provided in the second formulation. Examples of suitable anionic surfactants that can be provided in the second formulation include, without limitation, sulfates such as alkyl sulfates (e.g., C₈-C₁₈ linear or branched alkyl sulfates such as sodium lauryl sulfate (SLS), and sodium tetradecylsulfate), sulfonates such as alkyl sulfonates (e.g., C₆-C₁₈ linear or branched alkyl sulfonates such as sodium octane sulfonate and sodium secondary alkane sulfonate, alkyl ethoxysulfates, fatty acids and fatty acid salts (e.g., C₆-C₁₆ fatty acid soaps such as sodium laurate), and alkyl amino acid derivatives. Other examples may include sulfate derivatives of alkyl ethoxylate propoxylates, alkyl ethoxylate sulfates, alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methylsulfonates, C₆-C₁₈ alkyl, aryl, or alkylaryl ether carboxylates, and the like. Some non-limiting example embodiments of specific anionic surfactants that can be provided in the second formulation include SLS compound commercially available under the tradename STEPANOL WA-EXTRA HP (Stepan Chemical) and a linear alkyl sulfate commercially available under the tradename TEXAPON 842 UP (BASF Corporation).

Further example embodiments of anionic, non-ionic and/or amphoteric surfactants that can be provided in the second formulation include, without limitation, alkali metal alkyl sulfates, alkyl sulfonates including secondary alkane sulfonates (also referred to as paraffin sulfonates), alkyl diphenyl ether disulfonates, fatty acid soaps, and mixtures thereof. Such surfactants can have alkyl groups averaging about 8 to about 20 carbon atoms. An example of a suitable secondary alkane sulfonate suitable for providing in the second formulation is HOSTAPUR SAS, manufactured by Farbwerke Hoechst A.G. (Frankfurt, Germany). Some non-limiting examples of non-ionic surfactants include amine oxides, such as trialkyl amine oxides, as represented in the formula expression RR′R″NO, in which R′ and R″ may be alkyls of 1 to 3 carbon atoms and are preferably methyls, and R is an alkyl of about 10 to 20 carbon atoms. When R′ and R″ are both methyl and R is alkyl averaging about 12 carbon atoms, the structure for dimethyldodecylamine oxide, a particularly preferred amine oxide, is obtained. A representative example of a surfactant that includes dimethyldodecylamine oxides is commercially available under the trademark AMMONYX LO (Stepan Chemical). Other types of suitable surfactants for use in the second formulation include betaines, imidazolines and certain quaternary phosphonium and tertiary sulfonium compounds.

Preferably, any surfactant provided in the first formulation with concentrated hypohalite is limited to a betaine or an Alkyldiphenyloxide Disulfonate, such as the types commercially available under the tradename DOWFAX (Dow Inc., Michigan).

The one or more surfactants (e.g., one or more anionic, non-ionic and/or amphoteric surfactants) can be provided in one or both of the concentrated (first and second) formulations in an amount from about 0.1% to about 2% by weight (i.e., by weight of the combined concentrated formulations), or from about 0.2% to about 1.9% by weight. The one or more surfactants in the dilute cleaning formulations can be in an amount from about 0.01% to about 0.15% by weight, or from about 0.02% to about 0.13% by weight.

Any other one or more suitable solvents, excipients or other additives can also be provided within one or both of the concentrated formulations depending upon a particular application of use.

For example, water-miscible solvents may be provided in one or both of the first and second formulations including, without limitation, lower C₁-C₄ alcohols (e.g., ethanol, t-butanol), ethylene glycol, propylene glycol, glycol ethers, and mixtures thereof. The use and amounts of one or more solvents in either first or second formulation will depend upon desired miscibility of components within water for such formulation.

In addition, one or more of dyes or other colorants can be added to provide an aesthetically pleasing look for each of the first and second formulations as well as the dilute cleaning formulation. In certain embodiments, the first formulation can include a first colorant that yields a first color for the first formulation, and the second solution can include a second colorant that yields a second color for the second formulation. The second colorant differs in color from the first colorant so as to provide a clear visual distinction between the first and second formulations. In addition, when the first and second formulations with their respective first and second colorants are combined with water to form the dilute cleaning formulation, the mixture of the first and second colorants can result in the dilute cleaning formulation having a third color that differs from the first and second colors. This provides a further visual indication to the user that the first and second formulations have been combined to form the dilute cleaning formulation. Further, the composition an amounts of the first and second colorants in their respective concentrated formulations can be selected such that the third color is achieved upon sufficient mixing of the first and second formulations in the sufficient amounts and with a sufficient amount of water (e.g., at a sufficient dilution ratio), which indicates the cleaning solution has been successfully formed and is ready for use.

One or more thickeners may also be added to one or both of the first formulation and the second formulation, depending upon a particular use. Enzymes can also be added (e.g., to enhance cleaning operations).

Further, one or more fragrances can be added to one or both of the first formulation and the second formulation in any suitable amount(s) to mask or disguise the bleaching odor and/or to provide another aesthetically pleasing odor or smell to the dilute cleaning formulation. Fragrance compositions that are insensitive and unstable in the presence of concentrated hypohalite can be limited to the second formulation. When combining the first and second formulations and diluting with water, the buffer system components can also assist in maintaining stability of fragrances in the dilute cleaning formulation. Non-limiting examples of suitable fragrances include essential oils (e.g., from botanical or other naturally derived sources), synthetic fragrance oils and/or any other suitable type of fragrance composition that is stable at the concentration level of the concentrated and/or dilute hypohalite formulations, where the fragrance compositions are preferably rendered substantially miscible in the aqueous based formulations. In preferred embodiments, the one or more fragrances are limited to (i.e., only in) the second formulation, so as to increase the longevity of stability of the fragrances as well as amount of hypochlorite within the concentrated and dilute cleaning formulations. Some specific and non-limiting examples of fragrances that are provided in the second formulation include a perfume or essential oil resembling a soapy fragrance, lemon oil and/or yuzu oil.

The one or more fragrances may be provided in one or both of the first and second formulations in an amount from about 0.01% to about 10% by weight (i.e., by weight of the combined concentrated formulations), or from about 0.01% to about 5% by weight. Upon dilution, the amount of one or more fragrances in the dilute hypohalite formulation can be from about 0.001% to about 2% by weight (i.e., by weight of the dilute cleaning formulation).

The amount of water present in the combined concentrated formulations can be from about 40% to about 70% by weight (i.e., by weight of the combined concentrated formulations), or from about 45% to about 65% by weight.

As previously noted herein, the concentrated formulations can be diluted with any source of water, including tap water (i.e., water that has not been distilled or treated to remove minerals or other impurities). Depending upon the dilution ratio desired and/or configured for implementing with the concentrated formulation, the amount of water (e.g., tap water) that is within the dilute cleaning formulation can be from about 80% to about 98% by weight (i.e., by weight of the dilute cleaning formulation), or from about 85% to about 95% by weight. Thus, the majority of the formulations, both concentrated and dilute, contain water and further can contain tap water.

The pH of the first formulation, second formulation and dilute cleaning formulation can be selectively controlled based upon the amount of hypohalite as well as the amount and/or types of pH adjusting agents provided in the first and/or second formulations. In example embodiments, at least the concentrated first formulation (including hypohalite) is prepared so as to have a pH of at least about 12, such as a pH from about 12 to about 14. The pH of the dilute cleaning formulation is lower than that of at least the first formulation and is no greater than about 13, or a pH from about 11 to about 13. The pH of at least the first formulation can be greater than the pH of the dilute cleaning formulation by an amount of from about 0.3 to about 1.5, or from about 0.5 to about 1.2 (i.e., range of increase in pH between dilute cleaning formulation and concentrated first formulation).

As previously noted herein, the dual chamber storage system can comprise a single container or pod that is subdivided with any suitable interior wall or barrier into at least two chambers that are self-contained, separated and isolated from each other within the single container or pod. For example, the single container or pod can include a first chamber that stores the first formulation and a second chamber that stores the second formulation. Alternatively, the dual chamber storage system can comprise at least two separate containers, each of which includes a single chamber for storage of one of the concentrated formulations. For example, the system can include a first container that stores the first formulation and a second container that stores the second formulation. The sealing structure that seals the openings of each of the first chamber and second chamber (for a dual chamber system) or a first container and a second container is formed of a suitable material that is bleach stable so as to not degrade or deteriorate when storing the concentrated formulations prior to being used. In example embodiments for the dual chamber system, a single sealing structure can be applied so as to cover a first opening of the first chamber containing the concentrated first formulation and a second opening of the second chamber containing the concentrated second formulation such that peeling away the single sealing structure results in opening both chambers. In a system including two separate containers, a separate sealing structure can be provided for a first opening of the first container containing the concentrated first formulation and a second opening of the second container containing the concentrated second formulation.

The system can further comprise a cleaning product dispensing container to receive to receive some or all of each of the first and second formulations along with a select amount of water at the desired dilution ratio between each concentrated formulation and the water. The dispensing container can have a volume that is greater than one or both of the chambers or containers which store the first and second formulations. The dispensing container can facilitate sufficient mixing of the first and second formulations with water so as to achieved a relatively uniform mixture of components within the dispensing container prior to use.

In some example embodiments, the concentrated formulations can be provided in a small dual capsule, dual pod or other dual container that is divided into two chambers each of which stores a small amount of concentrated first or second formulation of no greater than about 10 ounces (about 283 grams), such as no greater than about 5 ounces (about 142 grams), or from about 1 ounce (about 28 grams) to about 2 ounces (about 57 grams). In such embodiments, the chambers of the dual pod or dual container are opened and the entire amount of each concentrated formulation is poured into the dispensing container for combining with water to form the dilute cleaning formulation. Thus, each dual pod or dual container is limited to a single use in which the entire contents of each chamber are dispensed within the dispensing container.

Alternatively, one or both of the first container and the second container can store an amount of concentrated formulation that is greater than a designated amount to be diluted for a given dilute cleaning formulation. For example, the first container (which stores the first formulation) and/or the second container (which stores the second formulation) can include concentrated formulation and an enclosure, e.g., in the form of a lid or cap, that also functions as a measurement vessel by filling a portion of or the entire volume of the cap with concentrated formulation for combining with the other components and water in the dispensing container. In such embodiments, the first container and/or the second container can include 5 ounces or more of concentrated formulation, where a designated smaller amount of concentrated formulation, such as 1 ounce, is combined with other components and diluted with water in the dispensing container prior to sue. This facilitates forming a number (e.g., 5 or more) of dilute cleaning formulations of a certain volume within the dispensing container before the first container and/or the second container of concentrated formulation is entirely depleted (i.e., the first formulation and/or the second formulation is entirely used).

The dispensing container, which can be of greater size/volume in relation to the first container and/or the second container, can be in any form that facilitates storage of the dilute cleaning formulation as well as delivery or dispensing of the dilute cleaning formulation in any desired manner for its intended use. For example, the dilute cleaning formulation may be used as an additive in laundry or other cleaning operations for providing or enhancing cleaning and/or oxidative treatment/stain removal for clothing, blankets or other textiles. In such case, the dispensing container may be in the form of a bottle or jug with a suitable opening or spout that facilitates pouring of dilute cleaning formulation from the dispensing container. The dispensing container can also include a lid or cap that also facilitates measurement of a suitable amount of dilute cleaning formulation to be added, e.g., to a laundry cycle. In other example embodiments, such as where the dilute cleaning formulation is used for cleaning, sanitizing and/or disinfecting an object or a surface, the dispensing container can include enclosure structure comprising a dispenser such as a pump spray nozzle or other suitable delivery structure that facilitates delivery of the dilute cleaning formulation as a liquid stream, a spray or a mist from the dispensing container. The concentrated first and second formulations as well as the dilute cleaning formulation formed from such concentrated formulations are rendered very stable for an extended period of time (e.g., for days) without significantly altering the hypohalite amount or the degradation or decomposition of other components within the concentrated formulations and the dilute cleaning formulation, thus providing a long shelf life for the concentrated formulations prior to as well as after dilution.

For example, a first formulation including concentrated hypohalite as described herein can be shelf stable such that an initial concentrated sodium hypochlorite level is maintained at greater than 50% of the initial concentrated sodium hypochlorite level after a period of about 48 hours and at a temperature of about 60° C. Further, components sensitive to concentrated hypohalite, such as certain surfactants and fragrances, are also maintained at greater than 50% of their initial concentrations after the same time period and temperature condition. A dilute cleaning formulation formed from combining the first and second formulations with water as described herein can be shelf stable such that an initial dilute sodium hypochlorite level is maintained at greater than 50% of the initial dilute sodium hypochlorite level after 168 hours at 60°.

The dilute cleaning formulations as described herein are very effective in oxidative stain removal as well as in cleaning and antimicrobial/antibacterial/antiviral efficacy with regard to sanitizing or disinfecting objects or surfaces for a variety of different bacteria, fungi and viruses. Antibacterial and antiviral efficacy (resulting in a desirable kill/reduction) can be achieved with contact times of 10 minutes or less, and even 5 minutes or less for certain embodiments. For example, dilute cleaning formulations as described herein are effective (i.e., cause a reduction in number, e.g., at least a 3 log reduction) against both gram-positive and gram-negative bacteria (e.g., Escherichia coli, Clostridioides difficile, Staphylococcus aureus, Salmonella enterica, etc.) within 10 minutes of exposure. In addition, diluted cleaning compositions as described herein exhibit at least a 2 log reduction (e.g., at least a 3 log reduction, or at least a 5 log reduction, or even at least a 6 log reduction) in one or more viruses (e.g., Influenza A, Human Coronavirus, Human Rotavirus, Murine Norovirus, etc.) within 10 minutes of exposure.

In use, a user or consumer of the cleaning concentrate dilution system opens the dual chamber of a sealed container or opens first and second containers, which respectively contain the concentrated first and second formulations, and also the empty dispensing container and combines a portion or the entire amount of each of the first formulation and the second formulation with a suitable amount of water at the designated dilution ratio (e.g., between 1:10 and 1:20) to form a dilute cleaning formulation that is stored within the dispensing container. The dispensing container can include suitable indicia with specific numeric or other gradations/graduation marks (e.g., graduation marks, such as in ounces, printed as a graduation scale on an interior and/or exterior surface of the second container) to indicate a specified amount of concentrated formulation to add to the dispensing container (e.g., a total amount of both the first and second formulations) and then an amount of water to fill to a specific graduation mark or level in the dispensing container that achieves the desired dilution ratio. Alternatively, the volume of the dispensing container can be set so that the precise dilution ratio is achieved by adding water, after adding the concentrated first and second formulation in their set amounts, to fill the entire volume (or a substantial portion thereof) of the dispensing container. For example, for a 1:12 dilution ratio, 2 ounces of concentrated formulation (e.g., 1 ounce of first formulation and 1 ounce of second formulation) can be added to the dispensing container, followed by filling the dispensing container with tap water to a specific level that corresponds with a graduation mark or level in the dispensing container (or filling substantially the entire volume of the dispensing container) that forms 24 ounces. Thus, the system or package facilitates easy formation of the dilute cleaning formulation by combining the concentrated first and second formulations with water at the precise amounts to achieve the precise dilution ratio and corresponding hypohalite concentration as well as precise concentrations of other components within the dilute cleaning formulation that is contained within the dispensing container.

### EXAMPLES

### Example 1—Concentrated First and Second Formulations

A dual chamber concentrated bleach system for preparing a dilute cleaning formulation includes a concentrated first formulation including hypochlorite and buffer system components, and a concentrated second formulation including surfactant and fragrance that are maintained separate from the concentrated hypochlorite prior to being diluted with water. The first and second formulations are provided within first and second chambers of a single pod or single container. The compositions with concentration ranges of each component in the first and second formulations are set forth in Table 1. The amount of first formulation to second formulation can be any suitable ratio (e.g., 90:10, 80:20, 50:50, etc.) as desired for a particular application, where the weight percentages of the components (based upon the combined weight of first and second formulation) listed in Table 1 stays the same.

TABLE 1
Bleach Dual Chamber

| | | Weight % of active |
|---|---|---|
| | | ingredients |
| | | (based upon combined weight |
| | | of first and second |
| | | formulations, with water |
| Chamber | Component | added as balance) |
| 1 | Sodium hypochlorite | 4-9 |
| | Sodium hydroxide solution | 0.20-0.40 |
| | (50 percent w/w) | |
| | Sodium carbonate | 0.25-0.75 |
| | (anhydrous) | |
| 2 | Sodium carbonate | 8-10 |
| | (anhydrous) | |
| | Alkyldiphenyloxide | 22-24 |
| | disulfonate (surfactant, e.g., | |
| | DOWFAX) | |
| | Sodium polyacrylate | 0.05-1.0 |
| | (stability agent, e.g., | |
| | SOKALAN) | |
| | Fragrance (e.g., Yuzu) | 4-6 |

The first and second formulations can be combined with water to obtain a dilute cleaning formulation as follows:

TABLE 2
Bleach Dilute Cleaning Formulation
(dilution ratio of 1:10 or greater)

| | Weight % (based upon total |
|---|---|
| Component | weight of dilute formulation) |
| Sodium Hypochlorite | 0.05-0.60 |
| Sodium Hydroxide | 0.010-0.035 |
| Sodium Carbonate | 0.10-0.50 |
| Alkyldiphenyloxide disulfonate | 0.30-1.20 |
| (surfactant, e.g., DOWFAX) | |
| Sodium polyacrylate (stability | 0.002-0.10 |
| agent, e.g., SOKALAN) | |
| Fragrance (e.g., Yuzu) | 0.30-0.45 |
| Water | Balance |

### Example 2—Stability of Concentrated Dual Chamber vs. Single Chamber Formulations

Concentrated bleach dual chamber formulations were prepared having components with weight percentages (based upon the combined weight of first and second concentrated formulations) and having components separated in first and second chambers or containers as described herein and set forth in Table 1. In particular, the concentrated bleach dual chamber formulations were prepared including hypochlorite within the first formulation in an amount of about 4.75% to about 4.90% by combined weight of the first and second formulations. Two concentrated dual bleach formulations were tested, in which all the components were the same with the exception of fragrance, and each component including fragrance provided at the same or substantially the same concentrations (where hypochlorite was provided within the 4.75-4.90% concentration range in each of the formulations). Two formulations were considered, including Yuzu as a first fragrance (Fragrance 1) in one formulation and a soapy or fresh scent fragrance (Fragrance 2) provided in another formulation, each fragrance being provided in the second chamber of the formulations. For comparison purposes, single chamber concentrated bleach formulations were also formed including the same components and at the same weight percentages as the concentrated bleach dual chamber formulations, where single chamber concentrated bleach formulations also included a formulation with Fragrance 1 and a formulation with Fragrance 2.

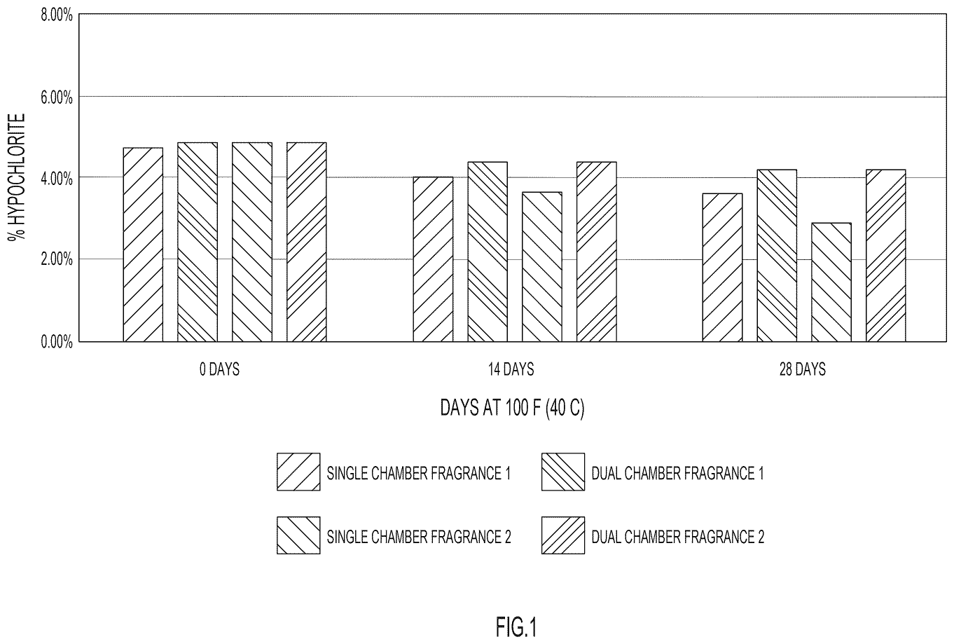

Two ounce samples of the dual chamber and single chamber concentrated bleach formulations were stored for a period of time, with the amount of hypochlorite within each sample being monitored over the time period to assess stability. After preparation, the formulations were stored at a temperature of about 100° F. (about 40° C.). During storage, the amount of hypochlorite in each sample was measured at different times (t=0 days, 14 days, and 28 days), and the results are provided in the data plotted in FIG. 1. The dual chamber concentrated bleach formulations (in which fragrance and other components were maintained separate from hypochlorite) were shown to have greater stability for both fragrances tested in comparison to the single chamber concentrated bleach formulations. This is apparent from the change/decrease in hypochlorite in the concentrated formulations during the time period tested. In particular, a reduction in hypochlorite content with the single chamber concentrated formulations was greater over time in comparison to the dual chamber concentrated bleach formulations (where the dual chamber concentrated formulations maintained hypochlorite content at above 4% by weight after 28 days of storage).

### Example 3—Cleaning/Disinfecting Efficacy of Concentrate Cleaning Formulations

Dual chamber concentrated formulations were formulated with concentrations as set forth in Table 1 herein, in which the concentrated first formulation included hypochlorite and the concentrated second formulation included fragrance and surfactant. The dual chamber concentrated formulations were stored for a suitable time period prior to being diluted so as to have dilute concentrations as set forth in Table 2 herein. In the test studies, dual chamber concentrated formulations were aged 4 weeks in concentrated form and at a temperature of 100° F. (37.8° C.), followed by dilution of the concentrated formulations (e.g., at a dilution ratio of about 1:10 or about 1:12) immediately prior to efficacy testing. In other test studies, diluted formulations (e.g., a dilution ratio of about 1:10 to about 1:12) were formed from the dual chamber concentrated formulations and then aged 4 weeks in diluted form at a temperature of 100° F. (37.8° C.) prior to efficacy testing. The aging process for each of the concentrated and diluted forms replicates a 1 year shelf life for the formulations prior to testing.

Efficacy testing was conducted for concentrated formulations aged first and then diluted and also aged diluted formulations in accordance with U.S. Environmental Protection Agency procedures as outlined in SOP Number MB-05-16 for antibacterial/sanitization/disinfection efficacy against Staphylococcus aureus (ATCC 6538). For each test, 60 carriers were inoculated and treated with one of the formulations to determine how many of the carriers were still positive after treatment over a contact time of about 4.5 minutes. In these test procedures, less than 5/60 is considered a passing test (effective sanitization), while 5/60 or greater is considered as failing. For the two types of formulations (aged in concentrated form first, then diluted prior to testing, and aged after dilution prior to testing), the test results were less than 5/60. Thus, both the aged concentrated formulations and the aged diluted formulations tested resulting in a PASS for the efficacy tests conducted.

Accordingly, the test results demonstrated an antibacterial/sanitizing efficacy of the formulations, even after aging (representing a shelf life of about 1 year) in both concentrated and diluted form, with a contact time of no greater than 10 minutes and even no greater than 5 minutes for Staphylococcus aureus, in which at least a 3 log reduction (e.g., at least a 5 log reduction, or at least a 6 log reduction) of the bacterial strain is achieved.

Thus, the dual chamber cleaning concentrate dilution system as described herein facilitates the formation of dilute hypohalite formulations from concentrated hypohalite formulations while maintaining separation of components that may be sensitive (e.g., subject to degradation or decomposition) to concentrated hypohalite from the concentrated hypohalite formulation. This renders the concentrated formulations as well as the dilute cleaning formulations formed from such concentrated formulations stable for with suitable shelf lives while maintaining efficacy in cleaning (e.g., mold decolorization) and antimicrobial/antiviral properties over their shelf lives.

The concentrated formulations can further be diluted with tap water to form the dilute formulations without jeopardizing stability of the dilute formulations. The provision of a system that includes a dual chamber or dual container configuration to separately store at least two concentrated formulations (one of which contains the concentrated hypohalite) and an empty dispensing container also facilitates ease of conversion of the combining of the concentrated formulations to form the dilute cleaning formulation for use.

While the invention has been described in detail and with reference to specific embodiments thereof, it will be apparent to one skilled in the art that various changes and modifications can be made therein without departing from the spirit and scope thereof.

What is claimed:

1. A cleaning concentrate dilution system including a concentrate comprising a first formulation and a second formulation, the system comprising:
(A) a first sealed container containing the first formulation, the first formulation comprising:
(i) a hypohalite in an amount from about 1% to about 20% by combined weight of the first formulation and the second formulation;
(ii) a first pH adjusting agent in an amount from about 0.01% to about 5% by combined weight of the first formulation and the second formulation; and
(iii) optionally, a first solvent, a first colorant, water, or any mixture or combination thereof;
(B) a second sealed container containing the second formulation, the second formulation comprising:
(i) a surfactant in an amount from about 1% to about 40% by combined weight of the first formulation and the second formulation;
(ii) a fragrance in an amount from about 0.01% to about 10% by combined weight of the first formulation and the second formulation; and
(iii) optionally, a second solvent, a second colorant, a polymer, water, one or more pH adjusting agents or any mixture or combination thereof; and
(C) at least one sealing structure that covers a first opening in the first container or a second opening in the second container or both the first and second openings; and
(D) a dispensing container having a greater volume than the first and second sealed containers combined, which is formatted to contain a stable dilute cleaning formulation comprising:
(i) the first formulation;
(ii) the second formulation; and
(ii) tap water;
wherein the dilute cleaning formulation has a 1:10-1:20 dilution of the first and second formulations combined with the tap water.

2. The concentrate dilution system of claim 1, wherein the second formulation further comprises the first pH adjusting agent.

3. The concentrate dilution system of claim 2, wherein the first pH adjusting agent comprises a carbonate.

4. The concentrate dilution system of claim 1, wherein the second formulation further comprises a stability agent.

5. The concentrate dilution system of claim 4, wherein the stability agent comprises a polyacrylate.

6. The concentrate dilution system of claim 1, wherein the second formulation further comprises an anionic surfactant.

7. The concentrate dilution system of claim 6, wherein the anionic surfactant comprises a sulfonate surfactant.

8. The concentrate dilution system of claim 1, wherein the dilute cleaning formulation exhibits at least a 3-log reduction in Staphylococcus aureus population within 10 minutes.

9. The concentrate dilution system of claim 1, wherein the combined weight of the first formulation and the second formulation is formed combining the first formulation with the second formulation at a weight ratio of the first formulation to the second formulation from 50:50 to 90:10.

10. A sealed concentrate cleaning product including a concentrate comprising a first formulation and a second formulation, the concentrate cleaning product comprising:
(A) a first sealed container containing the first formulation, the first formulation comprising:
(i) a hypochlorite in an amount from about 1% to about 20% by combined weight of the first formulation and the second formulation;
(ii) a first pH adjusting agent in an amount from about 0.01% to about 5% by combined weight of the first formulation and the second formulation; and
(iii) optionally, a first solvent, a first colorant, water, or any mixture or combination thereof;
(B) a second sealed container containing the second formulation, the second formulation comprising:
(i) a surfactant in an amount from about 1% to about 40% by combined weight of the first formulation and the second formulation;
(ii) a fragrance in an amount from about 0.01% to about 10% by combined weight of the first formulation and the second formulation; and
(iii) optionally, a second colorant, a second solvent, a polymer, water, one or more pH adjusting agents, or any mixture or combination thereof; and
C) at least one sealing structure that covers a first opening in the first container or a second opening in the second container or both the first and second openings and wherein the sealing structure covering the first opening comprises a bleach stable material.

11. The sealed concentrate cleaning product of claim 10, wherein the surfactant comprises an anionic surfactant.

12. The sealed concentrate cleaning product of claim 11, wherein the anionic surfactant comprises a sulfonate surfactant.

13. The sealed concentrate cleaning product of claim 10, wherein the second formulation further comprises a stability agent.

14. The sealed concentrate cleaning product of claim 13, wherein the stability agent comprises a polyacrylate.

15. A sealed concentrate cleaning product including a concentrate comprising a first formulation and a second formulation, the concentrate cleaning product comprising:
(A) a first sealed container containing the first formulation, the first formulation comprising:
(i) a hypochlorite in an amount from about 1% to about 20% by combined weight of the first formulation and the second formulation;
(ii) a first pH adjusting agent in an amount from about 0.01% to about 5% by combined weight of the first formulation and the second formulation;
(iii) a second pH adjusting agent in an amount from about 0.01% to about 5% by combined weight of the first formulation and the second formulation; and
(iv) optionally, a first colorant, water, or any mixture or combination thereof;
(B) a second sealed container containing the second formulation, the second formulation comprising:
(i) an anionic surfactant in an amount from about 1% to about 40% by combined weight of the first formulation and the second formulation;
(ii) a fragrance in an amount from about 0.01% to about 10% by combined weight of the first formulation and the second formulation; and
(ii) optionally, a polymer, a second colorant, water, one or more pH adjusting agents, or any mixture or combination thereof; and
C) at least one sealing structure that covers a first opening in the first container or a second opening in the second container or both the first and second openings and wherein the sealing structure covering the first opening comprises a bleach stable material.

16. The sealed concentrate cleaning product of claim 15, wherein the first pH adjusting agent comprises sodium hydroxide.

17. The sealed concentrate cleaning product of claim 15, wherein the second pH adjusting agent comprises a carbonate.

18. The sealed concentrate cleaning product of claim 15, wherein the second formulation further comprises a polyacrylate polymer.
